(19) United States
(12) Patent Application Publication
(10) Pub. No.: US 2025/0285140 A1
(43) Pub. Date: Sep. 11, 2025

(54) SYSTEM AND METHODS FOR EFFICIENT AND SUCCESSFUL OUTBOUND CAMPAIGNS IN CONTACT CENTER

(71) Applicant: NICE LTD., Ra'anana (IL)

(72) Inventors: Sanketh SHETTY, Pune (IN); Salil DHAWAN, Pune (IN); Prashant POLADIA, Pune (IN); Pramod GIRI, Pune (IN); Abhay KADU, Pune (IN)

(21) Appl. No.: 18/598,234

(22) Filed: Mar. 7, 2024

(51) Int. Cl. G06Q 30/0251; G06N 20/00; G06Q 30/0601

(52) U.S. Cl. CPC G06Q 30/0255; G06N 20/00; G06Q 30/0631

(57) ABSTRACT

Dynamic call queue systems and methods, and non-transitory computer readable media, include training a generative artificial intelligence (AI) model to output a product recommendation; querying the generative AI model for the product recommendation for each of the plurality of customers; extracting keywords from the product recommendation; converting the keywords into a first numeric representation; receiving a description of a new product; transforming the description of the new product into a second numeric representation; calculating a cosine similarity score (CSS); generating a customer likelihood score (CLS); calculating a sentiment score; retrieving a customer category score (CCS); calculating a customer propensity score (CPS) based on the CSS, the CLS, the sentiment score, and the CCS for each of the plurality of customers; sorting the plurality of customers based on the CPS; generating a dynamic list of customers; and scheduling outbound interactions based on the dynamic list of customers.

### COPYRIGHT NOTICE

A portion of the disclosure of this patent document contains material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### TECHNICAL FIELD

The present disclosure relates generally to methods and systems for generating a dynamic outbound interaction queue, and more particularly to methods and systems that calculate a customer propensity score for a new product and sort the dynamic outbound interaction queue based on the customer propensity score.

### BACKGROUND

The outbound contact center is a customer service or sales function staffed with agents that make outgoing phone calls (or other types of interactions) to customers and prospects. An outbound call campaign is a proactive approach where contact center agents initiate outbound calls (or other types of interactions) to reach potential customers, leads, or existing clients. Outbound campaigns are commonly used for sales, market research, lead generation, and telemarketing purposes.

One of the major key performance indicators (KPIs) of the contact center is the conversion rate, which is used to monitor the agents' leads and determine who may be interested in the company's product. Currently the challenge is that whenever any new product (or service) is launched, there is a random list of customers used to make outbound interactions and to inform about the product. Since the list is a static list, it is possible that the first few customers that the agent contacts will not be interested at all in the product. Some customers may not be interested, but may still hang on in the interaction, wasting the agent's time. This affects the overall outbound call campaign success rate and agent morale as well.

Accordingly, there is a need for generation of a dynamic queue of customers for outbound interactions that informs the contact center who is the best customer to contact.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a simplified block diagram of an embodiment of a dynamic call queue system according to embodiments of the present disclosure.

FIG. 2 is a flowchart of a method according to embodiments of the present disclosure.

FIG. 3 shows how a supervisor can begin the process of generating a dynamic customer list according to embodiments of the present disclosure.

FIG. 4 shows how a supervisor can generate a dynamic customer list by selecting a category and an agent according to embodiments of the present disclosure.

FIG. 5 shows an exemplary dynamic customer list according to embodiments of the present disclosure.

FIG. 6 is a block diagram of a computer system suitable for implementing one or more components in FIG. 1 according to one embodiment of the present disclosure.

### DETAILED DESCRIPTION

This description and the accompanying drawings that illustrate aspects, embodiments, implementations, or applications should not be taken as limiting-the claims define the protected invention. Various mechanical, compositional, structural, electrical, and operational changes may be made without departing from the spirit and scope of this description and the claims. In some instances, well-known circuits, structures, or techniques have not been shown or described in detail as these are known to one of ordinary skill in the art.

In this description, specific details are set forth describing some embodiments consistent with the present disclosure. Numerous specific details are set forth in order to provide a thorough understanding of the embodiments. It will be apparent, however, to one of ordinary skill in the art that some embodiments may be practiced without some or all of these specific details. The specific embodiments disclosed herein are meant to be illustrative but not limiting. One of ordinary skill in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

The present systems and methods generate a dynamic customer list based on each customer's probability of liking a new product for sale. With this list, the customers who have the highest probability of purchasing the product are prioritized to the top of the list and are contacted first. This enhances the overall effectiveness of the outbound campaign, while boosting agent morale since agents are able to sell more of the product, which boosts their confidence.

In various embodiments, a generative artificial intelligence (AI) model is used to capture, prioritize, and utilize the outbound campaign interactions. The present systems and methods ensure that customers who are most willing to purchase a new product are contacted first. In an exemplary embodiment, a generative AI model is trained on data sets such as past relevant transactions and/or activity of existing customers and past interaction transcripts of existing customers. In one or more embodiments, a customer propensity score (CPS) for a new product is calculated based on the output of the generative AI model. Like the best time to call metric, the CPS provides the best person to contact metric.

A dynamic customer list is prepared based on the CPS, where customers are listed from highest CPS to lowest CPS. Advantageously, the present systems and methods improve the conversion rate of contact centers, thus enabling them to deliver superior service to their end users. In addition, existing relationships with customers are enhanced, and agents are motivated to do a good job.

Dynamic and real-time prioritization of outbound interactions requires consideration of multiple factors and determining the exact outbound interactions that need to be prioritized first. The present disclosure uses out of the box (e.g., off the shelf) algorithms to determine the best customer to contact. In various embodiments, the generative AI model is trained with several different demographics to match the best agent to the best customer. In certain embodiments, the present systems learn from previous attempts at matching to iterate on future potential matches.

The present disclosure enhances the overall performance and conversion rate of the outbound call campaign and at the same time boosts agent morale. The generative AI model gives real-time insights about the customer that helps in predicting their likelihood for purchasing or selecting a product, which as described above is used to calculate the CPS. The AI based model dynamically predicts the probability of a customer opting for a product using recent relevant transactions and recent activity of existing customers, and recent interaction transcripts for existing customers. By “recent” is meant in the last year, the last six months, the last three months, or the last thirty days.

Overall, the present systems and methods facilitate the early identification of risk, decrease support calls, and increase customer satisfaction. The present systems and methods also facilitate building trust, reduce frustration, improve customer satisfaction, help to retain customers, enhance brand reputation, and generate revenue.

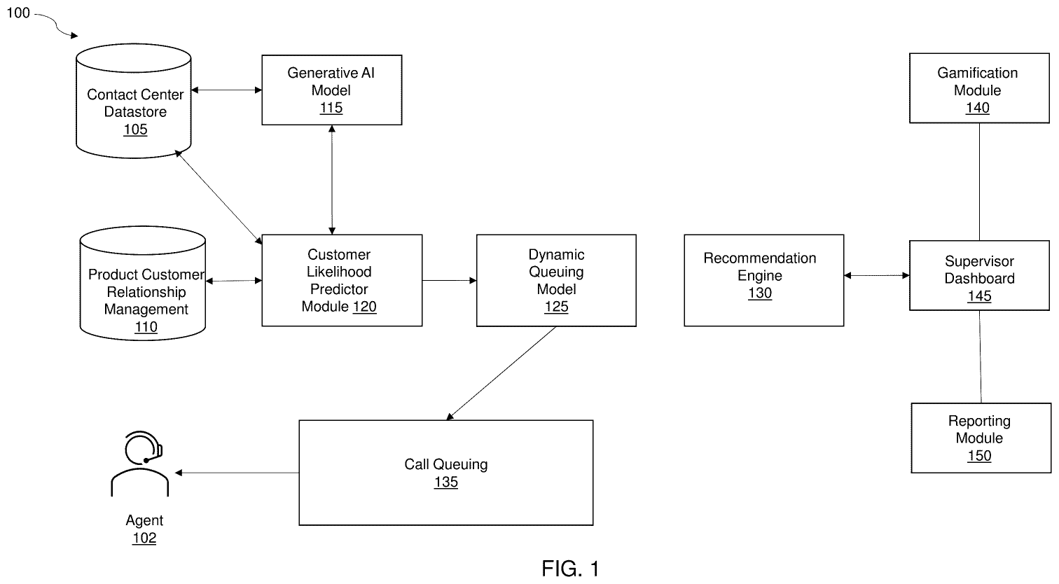

FIG. 1 illustrates an exemplary dynamic call queue system 100. It should be understood that while the system 100 is referred to as a dynamic call queue system, the system may also be used to contact customers via other channels including email, fax, chat, etc. A system flow for a method according to the present disclosure is also illustrated.

The contact center datastore 105 provides customer data, past and recent relevant transactions and activity of existing customers, and past and recent interaction transcripts for existing customers to the generative AI model 115. To train the generative AI model 115, a large amount of past data in some domain is collected and then the model 115 is used to generate data like it.

In one or more embodiments, during training, the generative AI model 115 first collects past customer demographic data, past purchase history, past browse history, and past interaction transcripts. The generative AI model uses recent data (e.g., recent customer demographic data, recent purchase history, and recent interaction transcripts) to output a product recommendation to be used to calculate the CPS. Customer demographic data includes age, income, and gender of the customer, and assists in determining the purchase pattern of the customer. Purchase history of the customer provides good data points and insights about the likes of the customer. The interaction transcripts help in making informed decisions of past customer interactions with agents and provide key insights.

Next, the generative AI model 115 identifies patterns in the collected data. Based on the identified patterns, the generative AI model 115 generates product recommendations by generating new content or items based on a customer's preferences and historical (or recent) interactions. The generative AI model 115 transforms the customer behavior data, item descriptions, and other features into a lower dimensional space using large language model (LLM) embeddings that capture the semantic meaning of products purchased in the past and recently, and recommend the next product.

In certain embodiments, the generative AI model 115 is trained on behavioral, demographic, psychographic, and geographic customer information, as well as past transcript data. Behavioral data includes purchase patterns, usage rate, and loyalty status. Demographic data includes age, income, and gender. Psychographic data includes personality, lifestyle, and interests. Geographic data includes the region where the customer resides. The generative AI model 115 is trained on this data in order to predict and provide keywords on product recommendations for a customer based on these insights.

The output from the generative AI model 115 using recent information and new product information from product customer relationship management database 110 are then used by the customer likelihood predictor module 120 to calculate the cosine similarity score (CSS) based on keywords associated with the product recommendations and the description of a new product provided by the product customer relationship management database 110.

In certain embodiments, the importance of the keywords and/or words in the description of the new product is determined. For example, in one or more embodiments, determining the importance of the keywords in the product recommendations and/or words in the description of the new product includes applying term frequency-inverse document frequency (TF-IDF) to the product recommendation and/or the new product description.

TF-IDF is a numerical statistic that reflects how important a word is in the text. TF-IDF is calculated by multiplying two metrics: how many times a word appears in the current text and the inverse document frequency of the word across all description text. “TF” is the scoring of the frequency of the word in a description text, and “IDF” is a scoring of how rare the word is across all description text. The TF-IDF score highlights words that are distinct (content useful information) in a given text.

$$TF ( t , d ) = \frac{number of times t a term appears in a document d}{total number of terms in d}$$

$$IDF ( t ) = log \frac{total number of documents}{number of documents with term t}$$

$$TF - IDF = TF ( t , d ) \times IDF ( t )$$

TF-IDF is a text vectorizer that transforms text into a vector that can be used to calculate the CSS. TF-IDF scores for individual words can subsequently be combined and used to convert the keywords in the product recommendation and/or the new product description into a vector or a numerical representation. In other words, TF-IDF is used to convert the text of the keywords in the product recommendation and the text of the new product description to numerical vectors. For example, a product recommendation of “women's green polyester vest with gold buttons” may be converted to the numerical representation [0.7, 0.5, 2.4, 1.5, 1.3, 0.8, 0.2] and a new product description of “Calvin Klein men's merino quarter zip sweater” may be converted to the numerical representation [1.5, 0.3, 1.3, 0.6, 1.4, 0.2, 0.4].

Cosine similarity is a mathematical measure used to determine the similarity between two vectors, which can be used in recommendation systems. In certain embodiments, the cosine similarity between a vector representing a customer's preferences (e.g., the product recommendation) and a vector representing item characteristics (e.g., the new product description) is calculated. Higher CSS indicate greater similarity between vectors, thereby facilitating recommendation of products that are more like the customer's preferences.

The customer likelihood predictor module 120 also calculates the customer likelihood score (CLS). In certain embodiments, the CSS and the description of the new product are used to train a random forest algorithm to generate the CLS. The CLS indicates the likelihood that a customer will make a purchase, engage with a product, or subscribe to a service. A customer having a high probability of opting for a product will have a high CLS. The CSS is typically derived from historical customer behavior data and predictive modeling techniques.

Random forest algorithms have three main hyperparameters, which need to be set before training. These include node size, the number of trees, and the number of features sampled. From there, the random forest classifier can be used to solve regression or classification problems.

The random forest algorithm is an ensemble learning method that builds a forest of decision trees during training and combines their predictions for more accurate and robust results. The algorithm is used to calculate the CLS, which represents the model's estimate of the likelihood that a given observation belongs to a particular class. A random forest classifier is trained on the CSS score and the new product description to generate an array of class probabilities where each row corresponds to the probability of belonging to a particular class. The array can then be used to assess the model's confidence by combining the predictions of all the decision trees.

The random forest algorithm is a commonly-used machine learning algorithm that combines the output of multiple decision trees to reach a single result. Its case of use and flexibility have fueled its adoption, as it handles both classification and regression problems, and makes more accurate and stable predictions. Based on the likeability, the random forest algorithm gives the customers a score, with the customers having a high probability for opting for the product having a high score.

Sentiment analysis involves assessing the sentiment or emotion expressed in textual data. The customer likelihood predictor module 120 also calculates a sentiment score using natural language processing (NLP) techniques to analyze customer reviews, feedback, or comments about products or services. The sentiment score provides an indication of the level of interest in products shown to a customer. The sentiment score helps in understanding whether the sentiment is positive, negative, or neutral, enabling businesses to gauge campaigns to ascertain the level of interest shown by the customer. The sentiment score is calculated for customer interactions in past campaigns to ascertain the level of interest shown by the customer.

The customer likelihood predictor module 120 can retrieve or assign a customer category score (CCS). Customers may be categorized based on demographics, behavior, purchase history, or other attributes. The CCS generally represents a customer's fit or affinity towards certain product categories or marketing strategies, aiding in targeted recommendations or personalized marketing efforts.

To calculate the CPS, the CSS, CLS, sentiment score and CCS are combined and averaged by the customer likelihood predictor module 120. The CPS indicates the likelihood that an interaction with a customer will be a success or provides the probability of success with the customer.

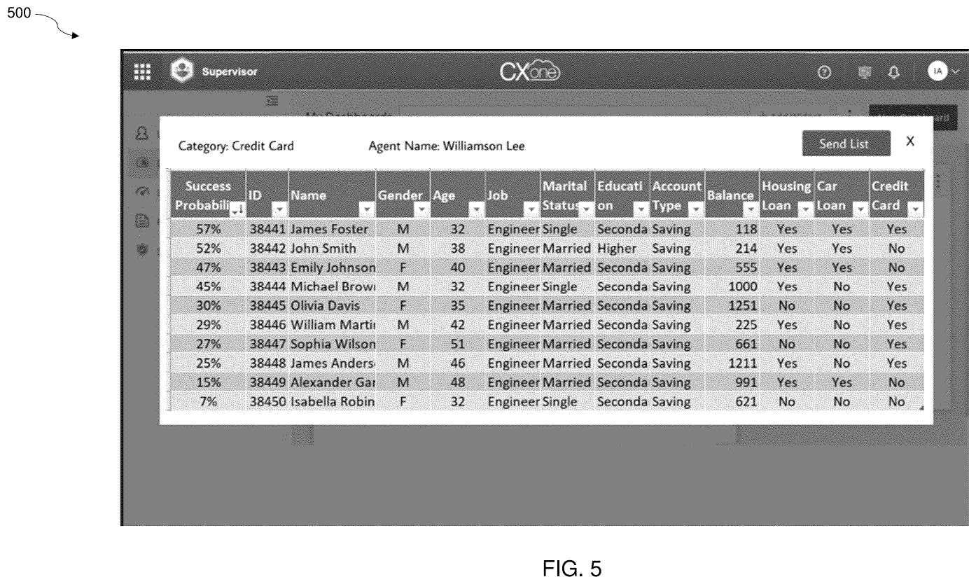

The customer likelihood predictor module 120 then provides the CPS to the dynamic queuing model 125. The dynamic queuing model 125 sorts the outbound customer list based on the CPS. For example, the customer list is sorted from high CPS to low CPS, and outbound interactions are scheduled based on the list. When an outbound call campaign is created, call queues are scheduled based on this dynamic customer list. This customer list is provided to call queuing 135, which then assigns agent 102 with the best customer to contact. In some embodiments, the customer with the highest CPS is assigned an agent with the highest skill to ensure that customers who have the highest chance of conversion are contacted first and that the highest skilled agent is first available. FIG. 5 provides an exemplary dynamic customer list 500.

The recommendation engine 130 ensures that the CPS is used in downstream applications including for gamification, the supervisor dashboard, and reporting purposes.

The gamification module 140 determines the number of successful conversions in an outbound campaign and rewards points to agents. In some embodiments, gamification is performed where an agent receives a reward for the success of every outbound interaction. Gamification ensures that agents are rewarded and recognized as part of successful outbound interaction. A successful outbound interaction or conversion occurs when customers are converted to sign up for the product in question. Gamification helps maintain high agent morale and helps efficiency of contact centers trend upwards or maintain a high efficiency over time.

The supervisor dashboard 145 allows supervisors to see the outcomes of the interactions prioritized by CPS. This provides the supervisor with insights into the overall success rate of the outbound call center campaign. For example, the supervisor can view customers with high CPS and how an agent performed on various interaction quality performance indicators.

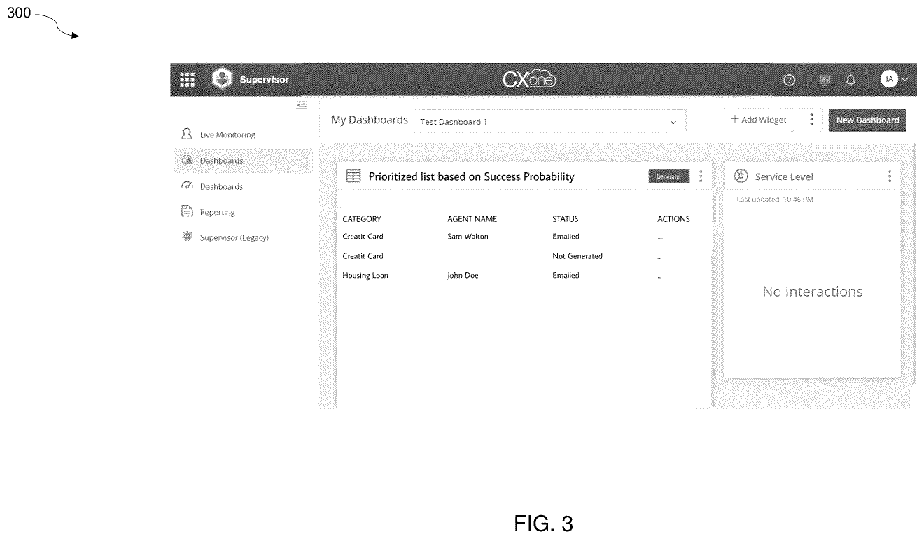

FIG. 3 illustrates a screenshot 300 that shows how a supervisor can begin the process of sending a dynamic customer list to an agent 102. In various embodiments, a supervisor can generate a prioritized list based on success probability as shown in FIG. 3. The supervisor can also look at a previously generated list to share with the agents.

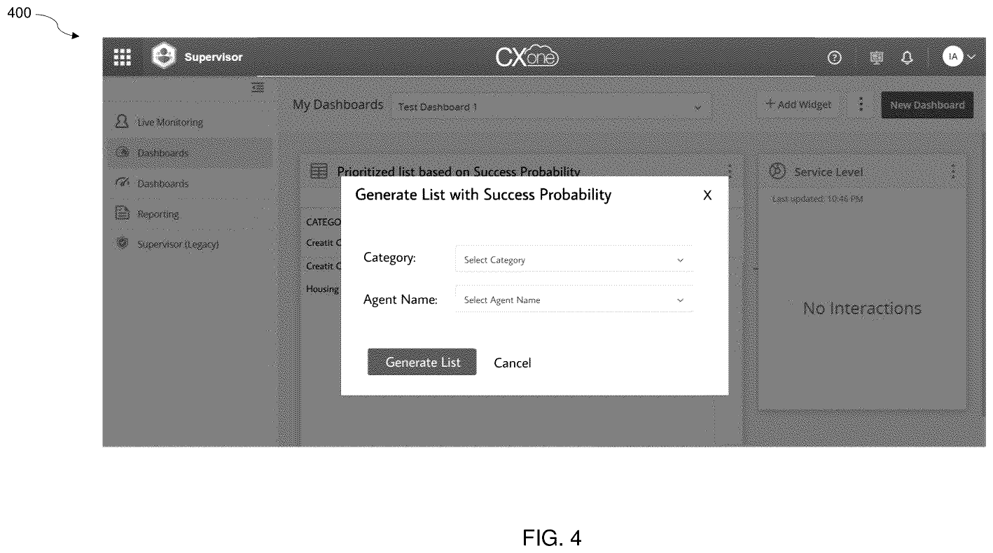

Once a supervisor presses the generate button in FIG. 3, the supervisor can generate a customer list for a specific category. FIG. 4 provides a screenshot 400 of how a supervisor can generate a list with success probability and can select the category and which agent(s) to send the list to.

FIG. 5 is a screenshot 500 of the dynamic customer list for the selected category that is sorted based on the success probability, along with the agent name.

Reporting module 150 automatically generates emails and send them to supervisors with performance indicators. This ensures that KPIs of the outbound campaign are reported appropriately. In some embodiments, the CPS is mapped against various performance indicators such as first call resolution, customer feedback, customer sentiment, and agent sentiment. As the customer propensity reports are generated, each interaction in the customer propensity report is categorized against the actual interaction with the customer on various performance indicators such as first call resolution and average handling time.

In situations where the CPS is high, but the call performance indicators are low, the interaction can be tagged for quality management and automated training programs can be assigned to the relevant agents. This ensures that any gaps in agent performance are immediately addressed to improve performance and contact center efficiency.

In one or more embodiments, the reporting can provide the conversion rate based on the queue prioritization, and the agent lead rate that indicates agent performance. A combination of these two metrics helps to identify success rate of the outbound campaign.

In an exemplary embodiment, dynamic call queue system 100 utilizes LLM processing techniques to analyze customer data and uses generative AI output to recommend potential customers for a new product based on cosine similarity and sentiment analysis. In one embodiment, an LLM prompt can be built as described below.

First, recentdata is prepared and preprocessed. The customer data includes customer information such as ‘customer_id’, ‘customer_name’, ‘description’, and ‘keywords.’ NLP libraries are used where the code imports natural language toolkit (NKTK) and uses its functionalities for tokenization, stopword removal, and sentiment analysis.

Next, feature engineering is performed. TF-IDF takes place where the apply_tfidf function tokenizes and vectorizes the recent customer data using TF-IDF. The CSS is calculated between the new product description and the customer descriptions based on their TF-IDF vectors. The calculation uses the cosine_similarity function from sklearn to find similarity scores between the new product description and existing customer descriptions. Sentiment analysis utilizes TextBlob to calculate sentiment polarity scores for each customer's transcript.

During machine learning, a random forest classifier is trained using CSS as input features and ‘customer_name’ as the target variable (assuming interest prediction for a new product). The random forest classifier predicts the likelihood of customer interest (‘probability_interested’) using the trained classifier.

During workflow execution, dynamic call queue system 100 uses a generative AI model to generate text and extracts keywords using rapid automatic keyword extraction (RAKE). TF-IDF calculation calculates the cosine similarity between the generative AI keywords and the new product description to find relevance. During sentiment analysis on customer transcripts, TextBlob is used on the transcript column of the customer data. To identify potential customers, dynamic call queue system 100 filters and sorts potential customers based on cosine similarity and predicted interest probabilities from the random forest model.

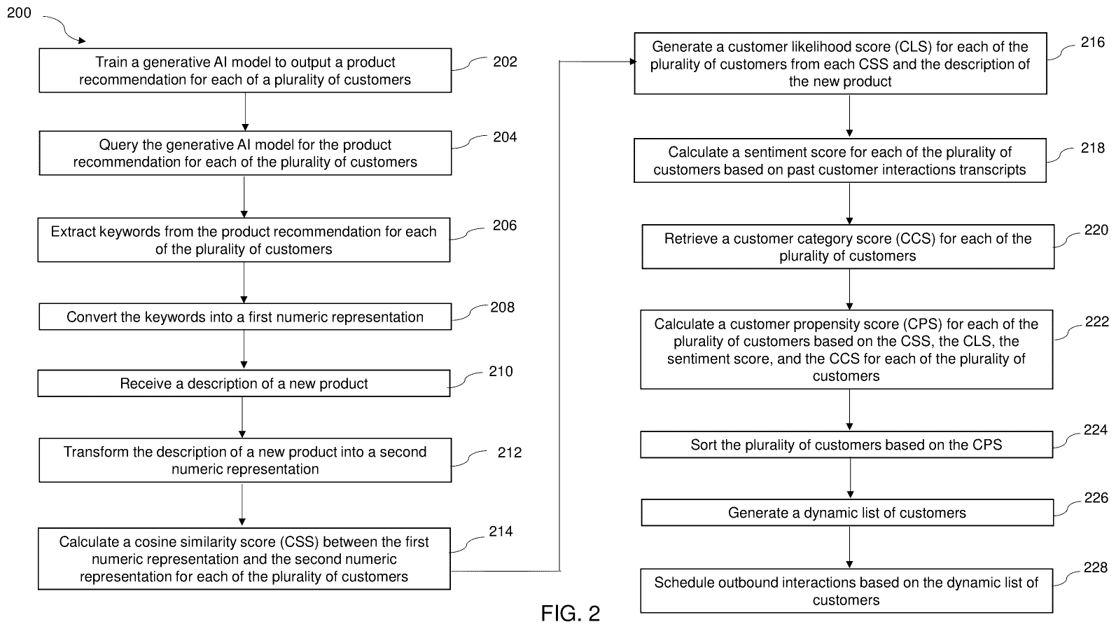

Referring now to FIG. 2, shown is an exemplary method 200 according to the present disclosure. At step 202, dynamic call queue system 100 trains a generative AI model 115 on past customer data, past customer activity, and past customer interaction transcripts to output a product recommendation for each of a plurality of customers. In several embodiments, the customer data and customer activity include behavioral data, demographic data, psychographic data, and geographic data.

At step 204, customer likelihood predictor module 120 queries the generative AI model 115 for the product recommendation for each of the plurality of customers. In one or more embodiments, prompts may be generated for each customer, and generative AI model 115 provides a product recommendation for a customer. Dynamic call queue system 100 uses recent customer data, recent customer activity, and recent customer interaction transcripts provided by contact center datastore 105 to output a product recommendation for each of the of the plurality of customers to calculate the CPS.

At step 206, customer likelihood predictor module 120 extracts keywords from the product recommendation for each of the plurality of the customers.

At step 208, customer likelihood predictor module 120 converts the keywords into a first numeric representation.

At step 210, customer likelihood predictor module 120 receives a description of a new product from product customer relationship management database 110.

At step 212, customer likelihood predictor module 120 transforms the description of the new product into a second numeric representation.

At step 214, customer likelihood predictor module 120 calculates a CSS between the first numeric representation and the second numeric representation.

At step 216, customer likelihood predictor module 120 generates a CLS for each of the plurality of customers from each CSS and the description of the new product. In one more embodiments, the method 200 further includes training a random forest algorithm to output the CLS.

At step 218, customer likelihood predictor module 120 calculates a sentiment score for each of the plurality of customers based on the past customer interaction transcripts.

At step 220, customer likelihood predictor module 120 retrieves a CCS for each of the plurality of customers.

At step 222, customer likelihood predictor module 120 calculates a CPS for each of the plurality of customers based on the CSS, the CLS, the sentiment score, and the CCS for each of the plurality of customers. In various embodiments, calculating the CPS includes determining a weighted average of a sum of the CSS, the CLS, the sentiment score, and the CCS.

$$CPS = \frac{W 1 * CSS + W 2 * CLS + W 3 * sentiment score + W 4 * CCS}{Wi}$$

$$CPS = \frac{{\sum }_{i = 1}^{n} WiXi}{{\sum }_{i = 1}^{n} Wi}$$

At step 224, dynamic queuing model 125 sorts the plurality of customers based on the CPS.

At step 226, dynamic queuing model 125 generates a dynamic list of customers, wherein a customer having a higher CPS is higher on the dynamic list than a customer having a lower CPS.

At step 228, dynamic queuing model 125 schedules outbound interactions based on the dynamic list of customers.

In one or more embodiments, method 200 further includes determining an outcome of at least a portion of the scheduled outbound interactions, and determining a value for a plurality of performance indicators of one or more agents handling the scheduled outbound interactions.

In certain embodiments, method 200 further includes rewarding an agent with a successful outcome. By “successful” is meant the customer buys the product, engages with the product, or subscribes to the service that the agent is selling.

In various embodiments, method 200 further includes generating a report including the dynamic list of customers, the outcome of at least a portion of the scheduled outbound interactions, and the value of the plurality of performance indicators of the one or more agents handling the scheduled outbound interactions, and automatically emailing the generated report to a supervisor of the one or more agents.

In many embodiments, method 200 further includes identifying the scheduled outbound interactions with a CPS higher than a predetermined threshold and a value of the plurality of performance indicators lower than a predetermined threshold, and automatically assigning training to one or more agents who handled the identified scheduled outbound interactions.

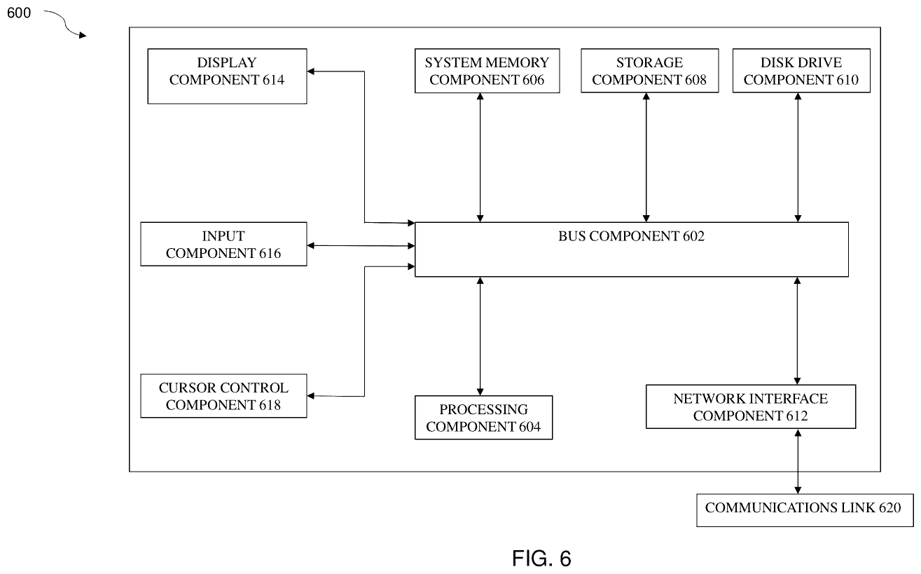

Referring now to FIG. 6, illustrated is a block diagram of a system 600 suitable for implementing embodiments of the present disclosure. System 600, such as part of a computer and/or a network server, includes a bus 602 or other communication mechanism for communicating information, which interconnects subsystems and components, including one or more of a processing component 604 (e.g., processor, micro-controller, digital signal processor (DSP), etc.), a system memory component 606 (e.g., RAM), a static storage component 608 (e.g., ROM), a network interface component 612, a display component 614 (or alternatively, an interface to an external display), an input component 616 (e.g., keypad or keyboard), and a cursor control component 618 (e.g., a mouse pad).

In accordance with embodiments of the present disclosure, system 800 performs specific operations by processor 604 executing one or more sequences of one or more instructions contained in system memory component 606. Such instructions may be read into system memory component 606 from another computer readable medium, such as static storage component 608. These may include instructions to train a generative artificial intelligence (AI) model on customer data, past customer activity, and past customer interaction transcripts, to output a product recommendation for each of a plurality of customers; query the generative AI model for the product recommendation for each of the plurality of customers; extract keywords from the product recommendation for each of the plurality of customers; convert the keywords into a first numeric representation; receiving a description of a new product; transform the description of the new product into a second numeric representation; calculate a cosine similarity score (CSS) between the first numeric representation and the second numeric representation for each of the plurality of customers; generate a customer likelihood score (CLS) for each of the plurality of customers from each CSS and the description of the new product; calculate a sentiment score for each of the plurality of customers based on the past customer interaction transcripts; retrieve a customer category score (CCS) for each of the plurality of customers; calculate a customer propensity score (CPS) for each of the plurality of customers based on the CSS, the CLS, the sentiment score, and the CCS for each of the plurality of customers; sort the plurality of customers based on the CPS; generate a dynamic list of customers, wherein a customer having a higher CPS is higher on the dynamic list than a customer having a lower CPS; and schedule outbound interactions based on the dynamic list of customers. In other embodiments, hard-wired circuitry may be used in place of or in combination with software instructions for implementation of one or more embodiments of the disclosure.

Logic may be encoded in a computer readable medium, which may refer to any medium that participates in providing instructions to processor 604 for execution. Such a medium may take many forms, including but not limited to, non-volatile media, volatile media, and transmission media. In various implementations, volatile media includes dynamic memory, such as system memory component 606, and transmission media includes coaxial cables, copper wire, and fiber optics, including wires that comprise bus 602. Memory may be used to store visual representations of the different options for searching or auto-synchronizing. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 600. In various other embodiments, a plurality of systems 600 coupled by communication link 620 (e.g., LAN, WLAN, PTSN, or various other wired or wireless networks) may perform instruction sequences to practice the disclosure in coordination with one another. Computer system 600 may transmit and receive messages, data, information and instructions, including one or more programs (i.e., application code) through communication link 620 and communication interface 612. Received program code may be executed by processor 604 as received and/or stored in disk drive component 610 or some other non-volatile storage component for execution.

The Abstract at the end of this disclosure is provided to comply with 37 C.F.R. § 1.72(b) to allow a quick determination of the nature of the technical disclosure. It is submitted with the understanding that it will not be used to interpret or limit the scope or meaning of the claims.

1. A dynamic call queue system comprising:
a processor and a non-transitory computer readable medium operably coupled thereto, the non-transitory computer readable medium comprising a plurality of instructions stored in association therewith that are accessible to, and executable by, the processor, to perform operations which comprise:
training a generative artificial intelligence (AI) model on past customer data, past customer activity, and past customer interaction transcripts, to output a product recommendation for each of a plurality of customers;
querying the generative AI model for the product recommendation for each of the plurality of customers;
extracting keywords from the product recommendation for each of the plurality of customers;
applying a term frequency-inverse document frequency (TF-IDF) text vectorizer to the keywords;
generating a first vector of the keywords from the application of the TF-IDF text vectorizer;
receiving a description of a new product;
applying the TF-IDF text vectorizer to the description of the new product;
generating a second vector of the description of the new product from the application of the TF-IDF text vectorizer;
calculating a cosine similarity score (CSS) between the first vector and the second vector for each of the plurality of customers;
generating a customer likelihood score (CLS) for each of the plurality of customers from each CSS and the description of the new product;
calculating a sentiment score for each of the plurality of customers based on the past customer interaction transcripts;
retrieving a customer category score (CCS) for each of the plurality of customers;
calculating a customer propensity score (CPS) for each of the plurality of customers based on the CSS, the CLS, the sentiment score, and the CCS for each of the plurality of customers;
sorting the plurality of customers based on the CPS;
generating a dynamic list of customers in real-time, wherein a customer having a higher CPS is higher on the dynamic list than a customer having a lower CPS; and
scheduling outbound interactions based on the dynamic list of customers.

2. The dynamic call queue system of claim 1, wherein the past customer data and past customer activity comprise behavioral data, demographic data, psychographic data, and geographic data.

3. The dynamic call queue system of claim 1, wherein the operations further comprise training a random forest algorithm to output the CLS.

4. The dynamic call queue system of claim 1, wherein calculating the CPS comprises determining a weighted average of a sum of the CSS, the CLS, the sentiment score, and the CCS.

5. The dynamic call queue system of claim 1, wherein the operations further comprise:
determining an outcome of at least a portion of the scheduled outbound interactions; and
determining a value for a plurality of performance indicators of one or more agents handling the scheduled outbound interactions.

6. The dynamic call queue system of claim 5, wherein the operations further comprise rewarding an agent with a successful outcome.

7. The dynamic call queue system of claim 5, wherein the operations further comprise:
generating a report including the dynamic list of customers, the outcome of at least a portion of the scheduled outbound interactions, and the value of the plurality of performance indicators of the one or more agents handling the scheduled outbound interactions; and
automatically emailing the generated report to a supervisor of the one or more agents.

8. The dynamic call queue system of claim 7, wherein the operations further comprise:
identifying the scheduled outbound interactions with a CPS higher than a predetermined threshold and a value of the plurality of performance indicators lower than a predetermined threshold; and
automatically assigning training to one or more agents who handled the identified scheduled outbound interactions.

9. A method for generating and scheduling a dynamic queue of customers, which comprises:
training a generative artificial intelligence (AI) model on past customer data, past customer activity, and past customer interaction transcripts, to output a product recommendation for each of a plurality of customers;
querying the generative AI model for the product recommendation for each of the plurality of customers;
extracting keywords from the product recommendation for each of the plurality of customers;
applying a term frequency-inverse document frequency (TF-IDF) text vectorizer to the keywords;
generating a first vector of the keywords from the application of the TF-IDF text vectorizer;
receiving a description of a new product;
applying the TF-IDF text vectorizer to the description of the new product;
generating a second vector of the description of the new product from the application of the TF-IDF text vectorizer;
calculating a cosine similarity score (CSS) between the first vector and the second vector for each of the plurality of customers;
generating a customer likelihood score (CLS) for each of the plurality of customers from each CSS and the description of the new product;
calculating a sentiment score for each of the plurality of customers based on the past customer interaction transcripts;
retrieving a customer category score (CCS) for each of the plurality of customers;
calculating a customer propensity score (CPS) for each of the plurality of customers based on the CSS, the CLS, the sentiment score, and the CCS for each of the plurality of customers;
sorting the plurality of customers based on the CPS;
generating a dynamic list of customers in real-time, wherein a customer having a higher CPS is higher on the dynamic list than a customer having a lower CPS; and
scheduling outbound interactions based on the dynamic list of customers.

10. The method of claim 9, which further comprises training a random forest algorithm to output the CLS.

11. The method of claim 9, wherein calculating the CPS comprises determining a weighted average of a sum of the CSS, the CLS, the sentiment score, and the CCS.

12. The method of claim 9, which further comprises:
determining an outcome of at least a portion of the scheduled outbound interactions; and
determining a value for a plurality of performance indicators of one or more agents handling the scheduled outbound interactions.

13. The method of claim 12, which further comprises rewarding an agent with a successful outcome.

14. The method of claim 12, which further comprises:
generating a report including the dynamic list of customers, the outcome of at least a portion of the scheduled outbound interactions, and the value of the plurality of performance indicators of one or more agents handling the scheduled outbound interactions; and
automatically emailing the generated report to a supervisor of the one or more agents.

15. The method of claim 14, which further comprises:
identifying the scheduled outbound interactions with a CPS higher than a predetermined threshold and a value of the plurality of performance indicators lower than a predetermined threshold; and
automatically assigning training to one or more agents who handled the identified scheduled outbound interactions.

16. A non-transitory computer-readable medium having stored thereon computer-readable instructions executable by a processor to perform operations which comprise:
training a generative artificial intelligence (AI) model on past customer data, past customer activity, and past customer interaction transcripts, to output a product recommendation for each of a plurality of customers;
querying the generative AI model for the product recommendation for each of the plurality of customers;
extracting keywords from the product recommendation for each of the plurality of customers;
applying a term frequency-inverse document frequency (TF-IDF) text vectorizer to the keywords;
generating a first vector of the keywords from the application of the TF-IDF text vectorizer;
receiving a description of a new product;
applying the TF-IDF text vectorizer to the description of the new product;
generating a second vector of the description of the new product from the application of the TF-IDF text vectorizer;
calculating a cosine similarity score (CSS) between the first vector and the second vector for each of the plurality of customers;
generating a customer likelihood score (CLS) for each of the plurality of customers from each CSS and the description of the new product;
calculating a sentiment score for each of the plurality of customers based on the past customer interaction transcripts;
retrieving a customer category score (CCS) for each of the plurality of customers;
calculating a customer propensity score (CPS) for each of the plurality of customers based on the CSS, the CLS, the sentiment score, and the CCS for each of the plurality of customers;
sorting the plurality of customers based on the CPS;
generating a dynamic list of customers in real-time, wherein a customer having a higher CPS is higher on the dynamic list than a customer having a lower CPS; and
scheduling outbound interactions based on the dynamic list of customers.

17. The non-transitory computer-readable medium of claim 16, wherein the operations further comprise:
determining an outcome of at least a portion of the scheduled outbound interactions; and
determining a value for a plurality of performance indicators of one or more agents handling the scheduled outbound interactions.

18. The non-transitory computer-readable medium of claim 17, wherein the operations further comprise rewarding an agent with a successful outcome.

19. The non-transitory computer-readable medium of claim 17, wherein the operations further comprise:
generating a report including the dynamic list of customers, the outcome of at least a portion of the scheduled outbound interactions, and the value of the plurality of performance indicators of one or more agents handling the scheduled outbound interactions; and
automatically emailing the generated report to a supervisor of the one or more agents.

20. The non-transitory computer-readable medium of claim 19, wherein the operations further comprise:
identifying the scheduled outbound interactions with a CPS higher than a predetermined threshold and a value of the plurality of performance indicators lower than a predetermined threshold; and
automatically assigning training to one or more agents who handled the identified scheduled outbound interactions.
